(19) United States
(12) Patent Application Publication
(10) Pub. No.: US 2022/0014613 A1
(43) Pub. Date: Jan. 13, 2022

(54) Holder for Flat Screen Electronic Devices

(71) Applicant: Clifford M. Cobb, JR., Oklahoma City, OK (US)

(72) Inventor: Clifford M. Cobb, JR., Oklahoma City, OK (US)

(21) Appl. No.: 16/927,430

(22) Filed: Jul. 13, 2020

(51) Int. Cl. H04M 1/04; B60R 11/02; A45C 11/00

(52) U.S. Cl. CPC H04M 1/04; A45C 2011/002; A45C 11/00; B60R 11/0241

(57) ABSTRACT

A holder and method of manufacture of the same for a flat screen electronic device includes a tube-shaped body with a flat bottom edge for resting on a surface and a top edge; a left side cradle formed between the top edge and the bottom edge along a left side of the body, having a left front detent and a left tilted rear resting edge; and a right side cradle formed between the top edge and the bottom edge along a left side of the body, having a right front detent and a right tilted rear resting edge; wherein the left side and right side cradles are configured to receive a flat screen electronic device in a resting position against the left tilted rear resting edge and the right tilted rear resting edge, maintained in the cradles by gravity and the detents, thereby transferring a weight of the flat screen electronic device through the body to the surface via the planar bottom edge.

### FIELD OF THE INVENTION

The present invention relates to stands, holders and props for flat screen electronic devices such as, but not limited to, smart phones, tablet computers, eBook readers and flat screen displays.

### BACKGROUND OF INVENTION

Use of flat-screen devices is prolific in modern society. Tablet-style smart phones (cell phones) have become so capable and popular, that many consumers use only their smart phones for personal computing, telecommunications, playing electronic gams and consuming streaming media such movies, television shows, pod casts, and on-demand videos. Electronic book readers, or eBook readers (“eReaders”), have also become extremely capable, and in many ways, are indistinguishable from smart phones and table personal computers in their capabilities, as well.

This means that consumers how use their flat screen display devices for many hours each day, which can lead to fatigue holding them and possible injury not just to the user's wrist and joints of the hands, but also the user's neck due to the head position looking down at the device.

### SUMMARY OF THE EXEMPLARY

### Embodiments of the Invention

Disclosed are a holder and a method of manufacture of the same for a flat screen electronic device includes a tube-shaped body with a flat bottom edge for resting on a surface and a top edge; a left side cradle formed between the top edge and the bottom edge along a left side of the body, having a left front detent and a left tilted rear resting edge; and a right side cradle formed between the top edge and the bottom edge along a left side of the body, having a right front detent and a right tilted rear resting edge; wherein the left side and right side cradles are configured to receive a flat screen electronic device in a resting position against the left tilted rear resting edge and the right tilted rear resting edge, maintained in the cradles by gravity and the detents, thereby transferring a weight of the flat screen electronic device through the body to the surface via the planar bottom edge.

### BRIEF DESCRIPTION OF THE DRAWINGS

The figures presented herein, when considered in light of this description, form a complete disclosure of one or more embodiments of the invention, wherein like reference numbers in the figures represent similar or same elements or steps.

FIG. 1 illustrates a perspective view of an example embodiment according to the present invention.

FIG. 2 depicts a side view of the example embodiment of FIG. 1.

FIG. 3 shows a front view of the example embodiment of FIG. 1.

FIG. 4 shows a top view of the example embodiment of FIG. 1.

FIG. 5 illustrates a manner of use of the example embodiment of FIG. 1.

### DETAILED DESCRIPTION OF ONE OR MORE EXEMPLARY EMBODIMENTS OF THE INVENTION

The present inventor(s) have recognized that currently available stands, holders and props for flat screen electronic devices such as, but not limited to, smart phones, tablet computers, eBook readers and flat screen displays, do not address all the needs in the art for all circumstances, usage scenarios and device configurations. For the purposes of this disclosure, these devices will be referred to collectively as flat screen devices.

At least one objective of the present invention is to provide a stand, holder or prop for a flat screen device which may be imprinted or otherwise be provided with surface indicia for personalization, such as hand-applied artwork, for advertisement, such as team and company logos, and for memorabilia, such as family photographs and special event commemoration, whereas currently available products are generally not provided with ample surface area for receiving such indicia.

At least another objective of the present invention is to provide such a stand, holder or prop for a flat screen device which is very low cost to manufacture either in bulk by mass production methods, such as molding, shaping, and computer-controlled machining, or by hand, such as by cutting and hand finishing, whereas currently available products are generally only mass produced using plastics and incur considerably high non-recurring expenses to develop a plastic mold.

It is still another objective of the present invention is to provide such a stand, holder or prop for a flat screen device to enhance sound quality of the typical miniature rear-facing speakers while the flat screen device is in the holder, whereas currently available products generally allow the device's sound to propagate away from the user while on video conferences, consuming streaming video, etc.

It is yet another objective of the present invention to allow for some embodiments to be realized in materials which are biodegradable to reduce plastic and electronic waste, whereas currently available products generally are manufactured with materials which do not readily break down in natural elements and which consume landfill space for many decades.

Various embodiments of the present invention will realize some or all of these objectives, and other, to the benefit of the users of flat screen devices and the communities in which they live.

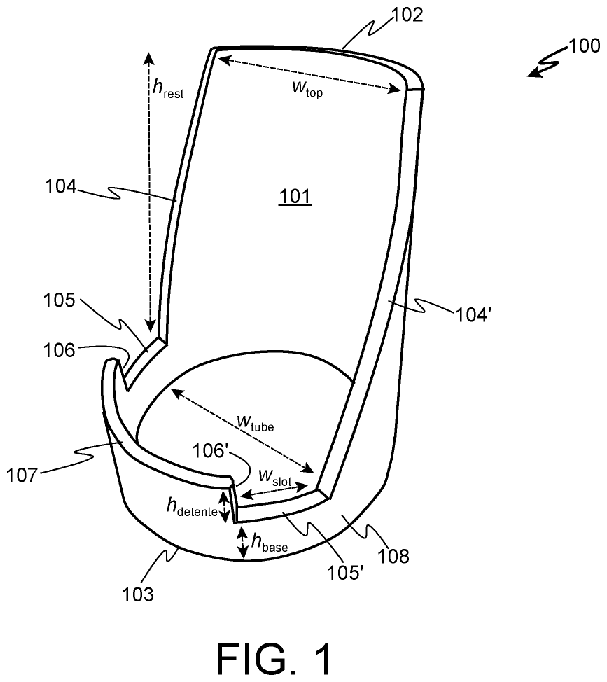

Turning now to FIG. 1, a perspective view of an example embodiment 100 according to the present invention is shown. This embodiment is generally made from a round tube stock having a tube diameter or width of w_{tube}. It is cut, shaped, molded, machined, or otherwise fabricated to have essentially symmetric features including a cradle areas 105 and 105′ for receiving a lower edge of a flat screen device, which are bounded by front detents 106 and 106′ for preventing the device from sliding forward and out of the holder 100, and tilted rear support surfaces 104 and 104′ leading from the rear of the cradle areas 105 and 105′ up to an upper edge 102. The front detents are, in this embodiment, interconnect by a lower front surface 107 which does not rise into the user's viewing range of the screen.

In at least this example embodiment which is useful for larger smart phones and for some smaller tablet devices, a body 108 is formed in a shape of a generally cylindrical tube having diameter w_{tube} of about 3.25″, the total height of the holder form the bottom edge 103 for resting on a table top to the top edge 102 is about 4″, the height hᵣₑₛₜ of rear support surfaces 104 and 104′ extending up from the cradle areas 105 and 105′ to the top edge 102 is about 3.25″, and the width wₛₗₒₜ of the cradle areas is about 1″. Further, this particular example embodiment tapers from being wider across the two cradle areas to being narrower across the top edge 102, from 3.25″ wide at the rear corners of the cradle areas to about 2.75″ across the top edge 102. Other dimensions are possible in other embodiments, which are wholly within the scope of the present invention. And, using stock materials of other cross-sectional shapes, such as triangular tube stock and square tube stock.

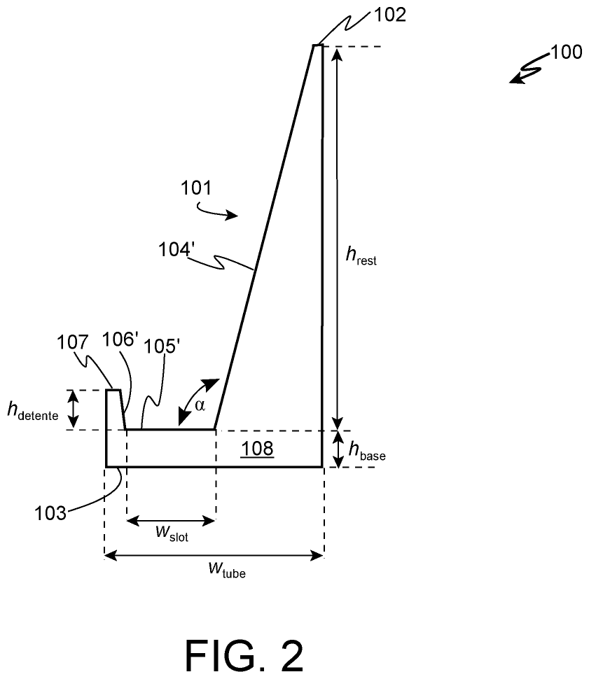

Referring now to FIG. 2, a right side view of the example embodiment of FIG. 1 is shown, in which additional details can be seen. First, note that the detente edge 106′ at the front of the cradle area 105′ may be formed at a right angle to the horizontal cradle surface, or formed at a slight angle tilting toward the front (left in this view) of the device, or in some other embodiments, tilted at an acute angle relative to the cradle surface. Also, the angle of tilt a between the cradle surface 105′ and the resting edge 104′ is about 113° (or 23° from vertical), which promotes a good reading and viewing angle for the user while also distributing the weight of the flat screen device in a manner to make it stable and less likely to tip over. The details, dimensions and angles of the left side of the device are preferably symmetric to these right side details, except mirrored or reversed about a vertical axis. In other embodiments, the detents, cradle surfaces and rest surfaces may be integrated in to one or more smooth curved surfaces instead of distinct linear segments, such as a general J-shape or check-mark shape.

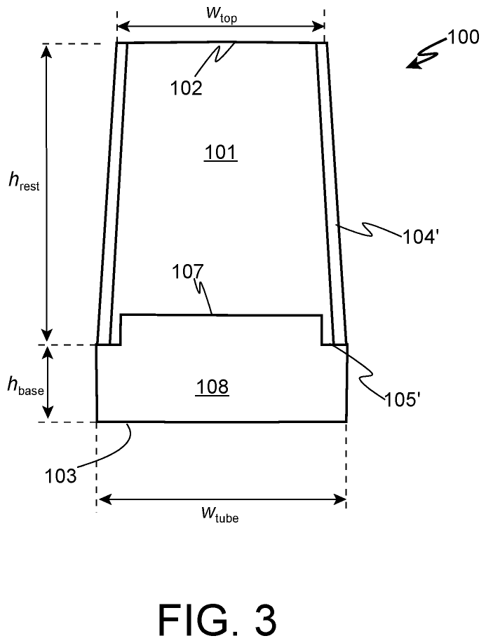

Referring now to FIG. 3, a front view of the example embodiment 100 of FIGS. 1 and 2 is shown. In this view, one can see that the concave surface 101 formed between the rest surfaces 104 and 104′ extends essentially from top to bottom of the holder, such that, no matter where the rear-facing speakers of the flat screen device are positioned on the device's back panel, they will feed their sound into the concave surface 101. The concave surface 101 then acts as an acoustic reflector, redirecting the sound toward the front of the flat screen device and towards the user, thereby enhancing the apparent volume of the flat screen device's speakers. Also, according to at least one embodiment, the height h_{base} of the base portion is about 0.5 to 0.75′.

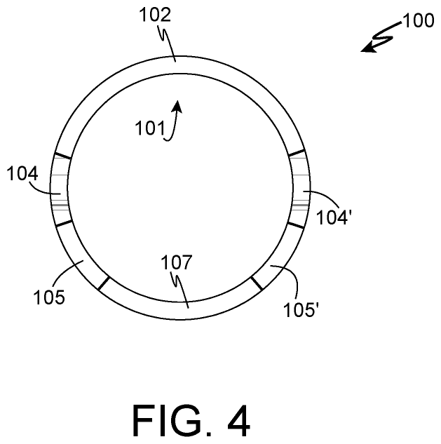

Now referring to FIG. 4, a top view of the example embodiment 100 of FIGS. 2, 3 and 4 is shown. In this embodiment, one can see that the top edge 102 and resting surfaces 104 and 104′ comprise half or more of the circumference of the holder, while the cradle areas 105 and 105′ and front edge 107 comprise half or less than the circumference of the holder. Other proportions are available in other embodiments, especially for embodiments which use other cross-sectional shapes than circular, such as a square or triangular tube stock.

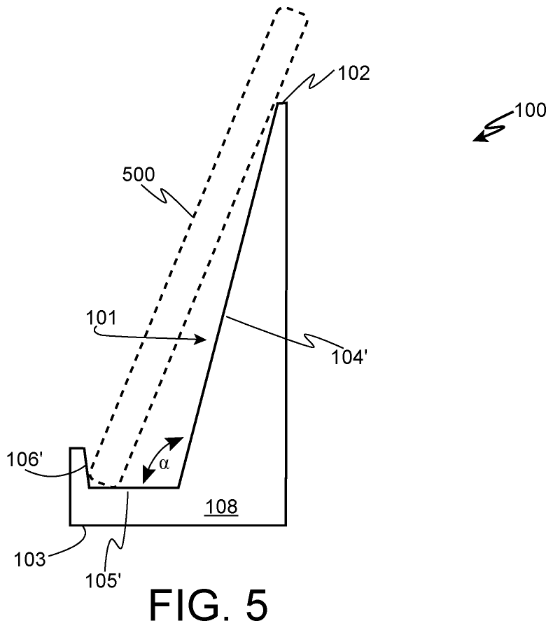

FIG. 5 provides a similar side view to that of FIG. 2, except that FIG. 5 includes an illustration of how a flat screen device 500 may be received into the cradle areas, resting on the cradle surfaces 105 and 105′, on the rest surfaces 104 and 104′ and top edge 102 (surfaces 105 and 104 are not visible in this perspective), held in place by the detents 106 and 106′ (detent 106 being hidden from this view).

There are several available methods to manufacture and fabricate embodiments according to the present invention. In one manner, a cylindrical cardboard tube stock, such as a spool from paper or a shipping tube, is marked and cut according to the foregoing shapes and, optionally, foregoing dimensions, by hand using a sharp knife, band saw, rotary tool or profile cutter. After cutting and shaping, protective coatings such as adhesive film or tape and any desired surface indicia may be applied by hand. The bottom of the holder may be left open, or may be provided with a circular plug or panel. This yields a light weight holder, fabricated of reclaimed materials and of biodegradable materials. And, it is not only personalizable, but also inexpensive to manufacture.

In another method of manufacture, the same shapes and, optionally, dimensions are realized from plastic tube stock, metal tube stock or fiberboard tube stock by injection molding, hot wire cutting, CNC machining, water knife cutting, blow molding or vacuum forming. This method may yield more durable embodiments.

Conclusion. The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The foregoing example embodiments do not define the extent or scope of the present invention, but instead are provided as illustrations of how to make and use at least one embodiment of the invention.

1. A holder for a flat screen electronic device comprising:
a body having a vertical cylindrical tube shape, a planar bottom edge for resting on a surface, and a top edge juxtaposed to the bottom edge;
a left side cradle formed between the top edge and the bottom edge along a left side of the body, having a left front detent and a left tilted rear resting edge; and
a right side cradle formed between the top edge and the bottom edge along a left side of the body, having a right front detent and a right tilted rear resting edge;
wherein the left side and right side cradles are configured to receive a flat screen electronic device in a resting position against the left tilted rear resting edge and the right tilted rear resting edge, maintained in the cradles by gravity and the detents, and configured to transfer a weight of the flat screen electronic device through the body to the surface via the planar bottom edge.

2. (canceled)

3. The holder as set forth in claim 2 wherein the round tube shape has a diameter of between 2.5 inches and 6 inches.

4. The holder as set forth in claim 3 wherein the diameter of between 3 inches and 4 inches.

5. The holder as set forth in claim 1 wherein the left tilted rear resting edge and the right tilted rear resting edge each are formed at an angle of between 10° and 30° from vertical.

6. The holder as set forth in claim 5 wherein the left tilted rear resting edge and the right tilted rear resting edge each are formed at approximately 23° from vertical.

7-8. (canceled)

9. A method of manufacturing a holder for a flat screen electronic device comprising the steps of:
forming a body vertical cylindrical tube shape, a planar bottom edge for resting on a surface, and a top edge juxtaposed to the bottom edge;
forming a left side cradle between the top edge and the bottom edge along a left side of the body, having a left front detent and a left tilted rear resting edge; and
forming a right side cradle between the top edge and the bottom edge along a left side of the body, having a right front detent and a right tilted rear resting edge;
wherein the left side and right side cradles are configured to receive a flat screen electronic device in a resting position against the left tilted rear resting edge and the right tilted rear resting edge, maintained in the cradles by gravity and the detents, and configured to transfer a weight of the flat screen electronic device through the body to the surface via the planar bottom edge.

10. (canceled)

11. The method of manufacture as set forth in claim 10 wherein the round tube shape has a diameter of between 2.5 inches and 6 inches.

12. The method of manufacture as set forth in claim 11 wherein the diameter of between 3 inches and 4 inches.

13. The method of manufacture as set forth in claim 9 wherein the forming of the left tilted rear resting edge and of the right tilted rear resting edge comprising forming each at an angle of between 10° and 30° from vertical.

14. The method of manufacture as set forth in claim 13 wherein the forming of the left tilted rear resting edge and of the right tilted rear resting edge comprises forming each at approximately 23° from vertical.

15-16. (canceled)
